(19) United States
(12) Patent Application Publication
(10) Pub. No.: US 2022/0414611 A1
(43) Pub. Date: Dec. 29, 2022

(54) DATA PROCESSING DEVICE, COOPERATIVE SYSTEM, DATA PROCESSING METHOD, AND DATA PROCESSING PROGRAM

(71) Applicant: NIPPON TELEGRAPH AND TELEPHONE CORPORATION, Tokyo (JP)

(72) Inventors: Akira KOYAMA, Musashino-shi, Tokyo (JP); Tomohiro KOKOGAWA, Musashino-shi, Tokyo (JP); Naoko KOSAKA, Musashino-shi, Tokyo (JP); Eiji KOBAYASHI, Musashino-shi, Tokyo (JP)

(73) Assignee: NIPPON TELEGRAPH AND TELEPHONE CORPORATION, Tokyo (JP)

(21) Appl. No.: 17/623,888

(22) PCT Filed: Jul. 4, 2019
(86) PCT No.: PCT/JP2019/026735

§ 371 Date: Dec. 30, 2021

(51) Int. Cl. G06Q 10/00; G06T 11/20

(52) U.S. Cl. CPC G06Q 10/20; G06T 11/206

(57) ABSTRACT

A cooperation apparatus (10) includes: an acquisition unit (131) that acquires damage information corresponding to previously-indicated aggregated items and restoration information corresponding to the previously-indicated aggregated items from a plurality of lower apparatuses; and an aggregation unit (132) that aggregates the plurality of damage information acquired by the acquisition unit (131) into information in a data format processible by an information processing apparatus higher than the own apparatus and aggregates the plurality of restoration information acquired by the acquisition unit (131) into information in a data format processible by the information processing apparatus higher than the own apparatus.

### TECHNICAL FIELD

The present invention relates to an information processing apparatus, a cooperation system, an information processing method, and an information processing program.

### BACKGROUND ART

In infrastructure companies or the like such as communication companies, a structure with which information for making a decision can be promptly shared between the respective layers of branches, operational company headquarters, and holding companies is, for example, needed.

Conventionally, if damage such as a failure is caused in a company's facility due to an earthquake, a typhoon, or the like, a branch first collects damage information and restoration information as soon as possible and reports the same to a headquarters. Here, the branch aggregates damage conditions using a GIS (Geographic Information System) used in the own company. Then, the branch grasps conditions or makes a decision on the basis of the aggregated information and escalates necessary information to a higher organization (for example, the headquarters).

The headquarters creates a condition recognition unification map using the GIS to organize the conditions of respective branches and recognize company-wide conditions. The headquarters makes use of the condition recognition unification map as information for making a decision. Then, the headquarters escalates organized information to a higher holding company.

The holding company aggregates information escalated from respective headquarters to create the condition recognition unification map of the whole group company and makes use of the created map as information for making a decision.

### CITATION LIST

### Patent Literature

[PTL 1] Japanese Patent No. 6423379

[PTL 2] Japanese Patent Application Laid-open No. 2019-008643

### SUMMARY OF THE INVENTION

### Technical Problem

Here, particularly, a response to restore an infrastructure has to be made extensively and cooperatively not only in the company concerned but also between a plurality of companies and group companies. However, since each of the group companies performs information management using the GIS of different specifications, it is difficult to share information on the GIS as it is.

Further, a higher holding company or an operational company headquarters is needed to aggregate information to unify condition recognition (COP: common operational picture) and make a decision. However, since a content for making a decision is different between the respective layers of the holding company, the operational company headquarters, and operational company branches, information to be aggregated is also different. Therefore, a lower organization requires a great deal of labor to escalate information needed by a higher organization, and the higher organization cannot efficiently aggregate substantial information.

Further, the escalation of information grasped by a branch to a headquarters becomes a large burden in a state in which an on-site operation responding to a disaster is extremely busy, and the escalation itself from the branch becomes difficult. As a result, a response to damage by the whole group may be delayed.

The present invention has been made in view of the above and has an object of providing an information processing apparatus, a cooperation system, an information processing method, and an information processing program that can properly perform the cooperation of damage information between multilayer organizations.

### Means for Solving the Problem

In order to solve the problem described above and achieve the object, the information processing apparatus of the present invention includes: an acquisition unit that acquires damage information corresponding to previously-indicated aggregated items and restoration information corresponding to the previously-indicated aggregated items from a plurality of lower apparatuses; and an aggregation unit that aggregates the plurality of damage information acquired by the acquisition unit into information in a data format processible by an information processing apparatus higher than the own apparatus and aggregates the plurality of restoration information acquired by the acquisition unit into information in a data format processible by the information processing apparatus higher than the own apparatus.

Further, the cooperation system of the present invention is a cooperation system including: an information providing apparatus; and an information processing apparatus provided at a level higher than the information providing apparatus, the information providing apparatus including an acquisition unit that acquires damage information corresponding to previously-indicated aggregated items and restoration information corresponding to the previously-indicated aggregated items from a plurality of lower apparatuses, a first aggregation unit that aggregates the plurality of damage information acquired by the acquisition unit into information in a data format processible by the information processing apparatus and aggregates the plurality of restoration information acquired by the acquisition unit into information in a data format processible by the information processing apparatus, and a transmission unit that transmits the damage information aggregated by the first aggregation unit and the restoration information aggregated by the first aggregation unit to the higher information processing apparatus, the information processing apparatus including an indication unit that indicates the aggregated items to be aggregated to the information providing apparatus, a reception unit that receives the aggregated restoration information and the aggregated restoration information from the information providing apparatus, a second aggregation unit that aggregates the plurality of damage information received by the reception unit and aggregates the plurality of restoration information received by the reception unit, and a visualization unit that develops the damage information aggregated by the second aggregation unit on a geographic information system (GIS) to be visualized and develops the restoration information aggregated by the aggregation unit on the GIS to be visualized.

Further, the information processing method of the present invention is an information processing method performed by an information processing apparatus, the information processing method including: a step of acquiring damage information corresponding to previously-indicated aggregated items and restoration information corresponding to the previously-indicated aggregated items from a plurality of lower information processing apparatuses; and a step of aggregating the plurality of acquired damage information into information in a data format processible by a higher information processing apparatus and aggregating the plurality of collected restoration information into information in a data format processible by the higher information processing apparatus.

Further, the information processing program of the present invention causes a computer to perform: a step of acquiring damage information corresponding to previously-indicated aggregated items and restoration information corresponding to the previously-indicated aggregated items from a plurality of lower information processing apparatuses; and a step of aggregating the plurality of acquired damage information into information in a data format processible by a higher information processing apparatus and aggregating the plurality of collected restoration information into information in a data format processible by the higher information processing apparatus.

### Effects of the Invention

According to the present invention, the cooperation of damage information between multilayer organizations can be properly performed.

### BRIEF DESCRIPTION OF DRAWINGS

FIG. 1 is a diagram showing an example of the configuration of a cooperation system according to an embodiment.

FIG. 2 is a diagram for describing the flow of the processing of the cooperation system shown in FIG. 1.

FIG. 3 is a diagram showing an example of the configuration of cooperation apparatuses shown in FIG. 1.

FIG. 4 is a diagram showing an example of the configuration of a cooperation apparatus shown in FIG. 1.

FIG. 5 is a sequence diagram showing the processing procedure of cooperation processing according to the embodiment.

FIG. 6 is a flowchart showing the processing procedure of aggregated information generation processing shown in FIG. 5.

FIG. 7 is a diagram showing an example of a computer in which the cooperation apparatuses are realized when a program is performed.

### DESCRIPTION OF EMBODIMENTS

Hereinafter, an embodiment of an information processing apparatus, a cooperation system, an information processing method, and an information processing program according to the present application will be described in detail on the basis of the drawings. Note that the present invention is not limited to the embodiment. A description will be given of an example of a case in which the information processing apparatus of the present invention is an apparatus included in a cooperation system that, when a disaster such as an earthquake and a typhoon or damage by a cyberattack or the like is caused, makes it possible to perform the sharing and cooperation of damage information and restoration information on the facilities of respective companies between respective business operators regardless of layers or in which the information processing apparatus is realized as one of the functions of the cooperation system.

### Embodiment

### [Outline of Cooperation System]

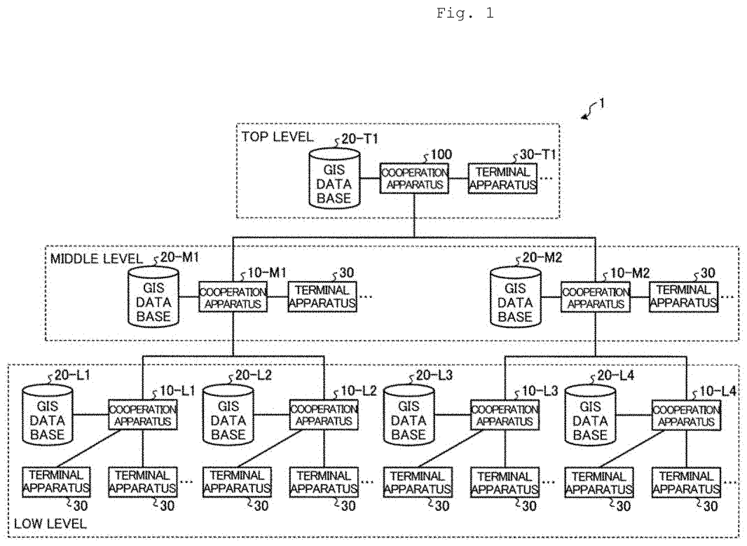

First, the configuration of a cooperation system according to the embodiment will be described using FIG. 1. FIG. 1 is a diagram showing an example of the configuration of the cooperation system according to the embodiment.

A cooperation system 1 shown in FIG. 1 is a system for cooperatively supplying damage information and restoration information on the facilities of respective companies between the companies, municipalities, national organizations, or the like when a disaster such as an earthquake and a typhoon is caused. For example, in FIG. 1, the cooperation system 1 performs the cooperation of information between the organizations of the three layers of a top level, a middle level, and a low level.

The top level includes, for example, nations, holding companies, or the like. The middle level includes prefectures, operational company headquarters, or the like. The low level includes, for example, cities, towns, and villages and operational company branches. In respective municipalities or respective companies, disaster control offices are provided. During a disaster, the failure conditions, restoration conditions, or the like of the facilities of own organizations are mapped into a GIS as position information. Note that the respective disaster control offices of the respective layers use the geographic information systems (GIS) of different specifications.

In the disaster control offices of the respective layers, a cooperation apparatus 100 (information processing apparatus), cooperation apparatuses 10-M1, 10-M2, and 10-L1 to 10-L4 (information processing apparatuses, information providing apparatuses) that perform the cooperation of damage information and restoration information between the respective layers are provided. Further, in the disaster control offices of the respective layers, GIS databases 20-T1, 20-M1, 20-M2, 20-L1, and 20-L2 that supply GIS data to the cooperation apparatuses 100, 10-M1, 10-M2, and 10-L1 to 10-L4, which are respectively connected, and terminal apparatuses 30-T1 and 30 connected to the respective cooperation apparatuses 100 are provided. The cooperation apparatuses 100, 10-M1, 10-M2, and 10-L1 to 10-L4 of the upper and lower layers are connected to each other via, for example, a network such as a wired or wireless LAN (Local Area network) and a WAN (Wide Area Network).

Note that the GIS databases 20-T1, 20-M1, 20-M2, 20-L1, and 20-L2 have different specifications. Further, the cooperation apparatuses 10-M1, 10-M2, and 10-L1 to 10-L4 will be represented as cooperation apparatuses 10 when described without distinction. The GIS databases 20-T1, 20-M1, 20-M2, and 20-L1 to 20-L4 will be represented as GIS databases 20 when described without distinction.

In the disaster control office of the top level, the cooperation apparatus 100, the GIS database 20-T1, and the terminal apparatus 30-T1 are provided. At the top level, the damage conditions of the whole nation or the whole group company are grasped, and damage information and restoration information on respective municipalities or respective operational companies are acquired by the cooperation apparatus 100.

The cooperation apparatus 100 is, for example, a server apparatus. In order to realize the COP of the whole nation or the whole group company, the cooperation apparatus 100 aggregates damage information and restoration information at the middle level and the low level using the GIS data of the GIS database 20-T1 and develops the aggregated information on the GIS to be visualized. On this occasion, the cooperation apparatus 100 indicates aggregated items (parameters) to be aggregated to the lower cooperation apparatuses 10, that is, the information providing apparatuses. The cooperation apparatus 100 gives feedback on the COP of the whole nation or the whole group company to the middle level and the low level of the lower layers.

The GIS database 20-T1 stores GIS data. The terminal apparatuses 30 are personal computers or the like. The terminal apparatus 30-T1 receives the provision of damage map information or restoration map information from the cooperation apparatus 100. At the top level, respective holding companies, national organizations, municipalities, or the like refer to map information on failures or restoration shown by the terminal apparatus 30-T1 to create restoration plans.

At the middle level, the cooperation apparatuses 10-M1 and 10-M2 and the GIS databases 20-M1 and 20-M2 that supply GIS data to the cooperation apparatuses 10-M1 and 10-M2, respectively, are provided. Further, the terminal apparatuses 30 that receive the provision of damage map information or restoration map information from the cooperation apparatuses 10-M1 and 10-M2 are connected to the cooperation apparatuses 10. The cooperation apparatuses 10 are, for example, server apparatuses.

At the middle level, the cooperation apparatuses 10-M1 and 10-M2 acquire damage information and restoration information on the subordinate low level from the cooperation apparatuses 10-L1 to 10-L4 and develop the acquired damage information and the restoration information on the GIS data of the GIS databases 20-M1 and 20-M2 to be visualized. Thus, resource adjustment or the like inside municipalities or operational companies is performed.

Then, the cooperation apparatuses 10-M1 and 10-M2 aggregate acquired damage information and restoration information into information in a data format processible by the cooperation apparatus 100 higher than the own apparatuses and transmit the aggregated information to the cooperation apparatus 100. On this occasion, since aggregated items to be aggregated are previously indicated by the cooperation apparatus 100, the cooperation apparatuses 10-M1 and 10-M2 aggregate the damage information and the restoration information corresponding to the previously-indicated aggregated items and transmit the aggregated information to the cooperation apparatus 100 of the top level.

At the low level, the cooperation apparatuses 10-L1 to 10-L4 and the GIS databases 20-L1 to 20-L4 that supply GIS data to the cooperation apparatuses 10-L1 to 10-L4, respectively, are provided. Further, the terminal apparatuses 30 that receive the provision of damage map information and restoration map information from the cooperation apparatuses 10-L1 to 10-L4 are connected to the cooperation apparatuses 10-L1 to 10-L4.

At the low level, the cooperation apparatuses 10-L1 to 10-L4 communicate with the subordinate terminal apparatuses 30, acquire damage information and restoration information on respective cities, towns, and villages and respective branches as soon as possible, and escalate the acquired information to the cooperation apparatuses 10-M1 and 10-M2 of the middle level. On this occasion, since aggregated items to be aggregated are previously indicated by the cooperation apparatus 100, the cooperation apparatuses 10-L1 and 10-L4 aggregate the damage information and the restoration information corresponding to the previously-indicated aggregated items. The cooperation apparatuses 10-L1 and 10-L4 aggregate the acquired damage information and the restoration information into information in a data format processible by the cooperation apparatuses 10-M1 and 10-M2 higher than the own apparatuses and transmit the aggregated information to the cooperation apparatuses 10-M1 and 10-M2 of the middle level.

Further, the cooperation apparatuses 10-L1 to 10-L4 develop the acquired damage information and the restoration information on the GIS data of the GIS databases 20-L1 to 20-L4 to be visualized. Thus, it is possible to grasp conditions inside cities, towns, and villages or branches.

[Flow of Processing of Cooperation System]

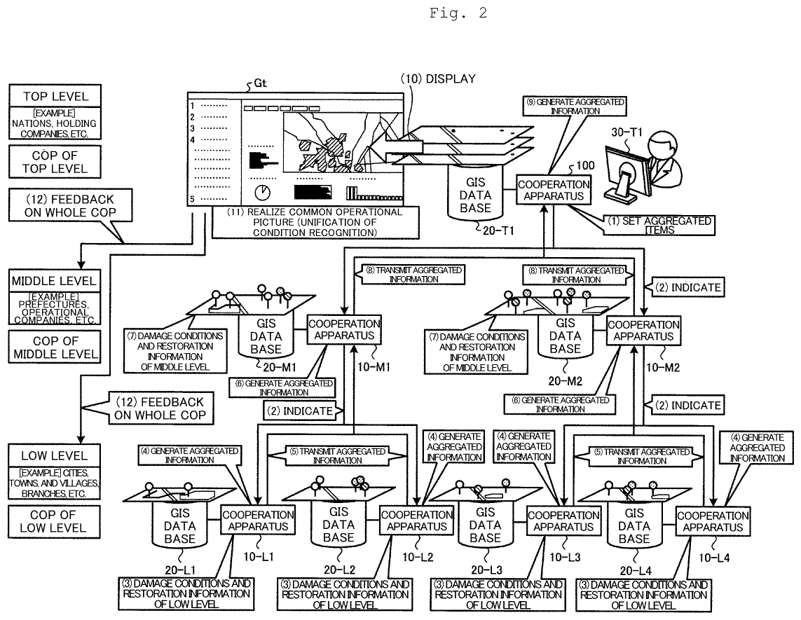

Next, the flow of the processing of the cooperation system 1 will be described with reference to FIG. 2. FIG. 2 is a diagram for describing the flow of the processing of the cooperation system 1 shown in FIG. 1.

First, at the top level, aggregated items to be aggregated among the items of damage information and restoration information are set by an operator's operation (see (1) in FIG. 2). The aggregated items are the items of information escalated to the higher cooperation apparatuses 100 and 10 by the lower cooperation apparatuses 10. The cooperation apparatus 100 indicates the aggregated items to be aggregated to the respective lower cooperation apparatuses 10 (see (2) in FIG. 2). Further, the cooperation apparatus 100 may set the items of information necessary for the COPs of the respective layers for each of respective municipalities or respective companies and indicate the same to the respective lower cooperation apparatuses 10.

Next, processing during a disaster will be described. First, at the low level, the cooperation apparatus 10-L1 in cities, towns, and villages or respective branches acquires damage information, restoration information, or the like corresponding to the items to be acquired from the respective terminal apparatuses 30 accommodated by the own apparatus (see (3) in FIG. 2). Then, in order to grasp conditions inside the cities, the towns, and the villages or inside the branches, the cooperation apparatus 10-L1 develops the damage information and the restoration information on the GIS to be visualized within the range of the cities, the towns, and the villages or the branches. Thus, the COP of the low level is realized.

Together with this, the cooperation apparatus 10-L1 aggregates the damage information and the restoration information corresponding to the previously-indicated aggregated items into information in a data format processible by the cooperation apparatus 10-M1 of the middle level to which the cooperation apparatus 10-L1 is connected (see (4) in FIG. 2) to generate the aggregated information, and transmits the aggregated information to the cooperation apparatus 10-M1 (see (5) in FIG. 2). Note that the other cooperation apparatuses 10-L2 to 10-L4 of the low level also perform the processing of (3) to the processing of (5) shown in FIG. 2 like the cooperation apparatus 10-L1 does.

Next, at the middle level, the cooperation apparatus 10-M1 in respective municipalities, respective operational companies, or the like receives the damage information and the restoration information corresponding to the previously-indicated aggregated items from the respective lower cooperation apparatuses 10-L1 and 10-L2. Then, the cooperation apparatus 10-M1 aggregates the plurality of received damage information and restoration information into information in a data format processible by the cooperation apparatus 100 of the top level to generate aggregated information (see (6) in FIG. 2).

In order to perform resource adjustment or the like inside the municipalities or the operational companies, the respective cooperation apparatuses 10-M1 develop damage information and restoration information on the GIS to be visualized within the range of the municipalities or the operational companies (middle level) (see (7) in FIG. 2). Thus, the COP of the middle level is realized. Together with this, the cooperation apparatus 10-M1 transmits the aggregated information to the cooperation apparatus 100 (see (8) in FIG. 2). Note that the other cooperation apparatus 10-M2 of the middle level also performs the processing of (6) to the processing of (8) shown in FIG. 2 like the cooperation apparatus 10-M1 does.

Then, at the top level, the cooperation apparatus 100 aggregates the plurality of aggregated information received from the respective cooperation apparatuses 10-M1 and 10-M2 to generate aggregated information on damage information and restoration information corresponding to the whole nation or the whole group company (see (9) in FIG. 2). Then, in order to grasp damage conditions and restoration conditions in the whole nation or the whole group company and make a decision for resource adjustment or the like across the country, the cooperation apparatus 100 develops the damage information and the restoration information on the whole nation or the whole group company (top level) on the GIS to be displayed (see (10) in FIG. 2).

As a result, the COP of the top level is realized by damage and restoration map information Gt in the whole nation or the whole group company (see (11) in FIG. 2). Then, the cooperation apparatus 100 gives feedback on the COP of the whole nation or the whole group company to the middle level and the low level of the lower layers (see (12) in FIG. 2). Thus, the COP of the whole nation or the whole group company can be shared by the middle level and the low level as well, and the unification of condition recognition between associated companies or municipalities can be realized.

As described above, the cooperation apparatuses 100 and 10 are arranged in the disaster control offices of the respective layers in the cooperation system 1. Then, the cooperation apparatuses 100 and 10 collect damage and restoration information on the respective layers from the GIS databases 20 of respective municipalities or respective companies and cooperate with each other. Thus, information is aggregated in a unified manner.

Together with this, items necessary for respective municipalities or respective companies and items to be escalated to higher organizations are previously set in the cooperation system 1, whereby the cooperation apparatuses 10 automatically acquire information necessary for the COPs of the respective layers and develop the acquired information on the geographic information systems (GIS) of the own companies. Then, the cooperation apparatuses 10 aggregate the acquired damage information and the restoration information into information in a data format processible by the higher cooperation apparatuses 100 and 10 and transmit the aggregated information to the cooperation apparatuses 100 and 10.

Thus, since it is possible to efficiently share information between a plurality of companies or a plurality of municipalities during a disaster or the like and make a prompt and efficient decision with the whole unified information according to the cooperation system 1, restoration from the disaster can be assisted at an early stage.

[Configuration of Cooperation Apparatus]

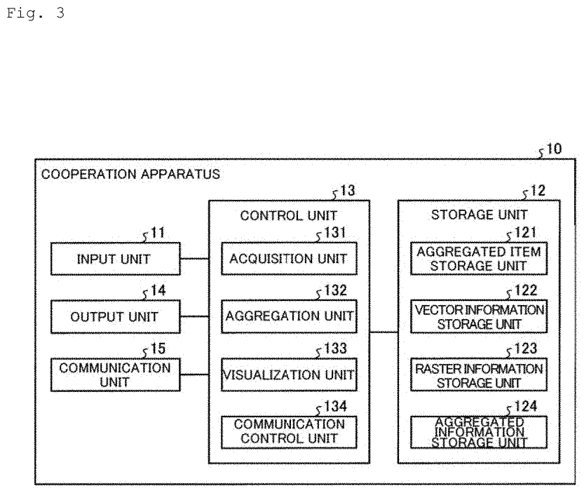

Next, the configuration of the cooperation apparatuses 10 will be described with reference to FIG. 3. FIG. 3 is a diagram showing an example of the configuration of each of the cooperation apparatuses 10 shown in FIG. 1. As shown in FIG. 3, the cooperation apparatus 10 has an input unit 11, a storage unit 12, a control unit 13, an output unit 14, and a communication unit 15.

The input unit 11 is an input interface that receives various operations from the operator of the cooperation apparatus 10. For example, the input unit 11 is constituted by an input device such as a touch panel, a voice input device, a keyboard, and a mouse.

The storage unit 12 is a storage device such as a HDD (Hard Disk Drive), a SSD (Solid State Drive), and an optical disk. Note that the storage unit 12 may be a semiconductor memory such as a RAM (Random Access Memory), a flash memory, and a NVSRAM (Non Volatile Static Random Access Memory) that is capable of rewriting data. The storage unit 12 stores an OS (Operating System) or various programs performed by the cooperation apparatus 10. In addition, the storage unit 12 stores various information used to perform programs. The storage unit 12 stores an aggregated item storage unit 121, a vector information storage unit 122, a raster information storage unit 123, and an aggregated information storage unit 124.

The aggregated item storage unit 121 stores information on aggregated items to be aggregated among the items of damage information and restoration information. The aggregated items are those indicated by the cooperation apparatus 100 of the top level.

The vector information storage unit 122 stores the vector information of failure information and restoration information. The vector information is constituted by the three elements of points, lines, and polygons and stored in association with attribute information and position information.

The raster information storage unit 123 stores the raster information of failure information and restoration information. The raster information is image data.

The aggregated information storage unit 124 stores aggregated information. The aggregated information is information generated by the cooperation apparatus 10 and in which failure information and restoration information acquired by the own apparatus are aggregated into information in a data format processible by the cooperation apparatuses 100 and 10 higher than the own apparatus. Note that the aggregated information is not limited to information generated by the own apparatus but may include information transmitted from lower apparatuses.

The control unit 13 controls the whole cooperation apparatus 10. The control unit 13 is, for example, an electronic circuit such as a CPU (Central Processing Unit) and a MPU (Micro Processing Unit) or an integrated circuit such as an ASIC (Application Specific Integrated Circuit) and a FPGA (Field Programmable Gate Array). Further, the control unit 13 has an internal memory for storing programs or control data defining various processing procedures and performs respective processing using the internal memory. Further, the control unit 13 functions as various processing units when various programs operate. The control unit 13 has an acquisition unit 131, an aggregation unit 132 (aggregation unit, first aggregation unit), a visualization unit 133, and a communication control unit 134 (transmission unit).

The acquisition unit 131 acquires damage information corresponding to previously-indicated aggregated items and restoration information corresponding to the previously-indicated aggregated items from a plurality of lower apparatuses. The acquisition unit 131 acquires information corresponding to items stored in the aggregated item storage unit 121 as the damage information and the restoration information. The acquisition unit 131 collects the vector information of the damage information and the vector information of the restoration information from the lower apparatuses. The acquisition unit 131 acquires the raster information of the damage information and the raster information of the restoration information from the lower apparatuses.

Here, the items of damage information and restoration information acquired by the acquisition unit 131 will be described. First, the items of information necessary for an own organization about damage information will be described. The items include, for example, position information f1 (prefectures, cities, towns, villages) and an information type f2 (personal damage, property damage (facility damage, office building damage), and a transmission interval (t(time)+LEVELS 1, 2, and 3+f1).

The thresholds of the items of damage information will be described using a case in which a damage level is classified into the three levels of large, medium, and small as an example. First, a LEVEL 3 represents a case in which the damage level is large and f2 is greater than 10. A LEVEL 2 represents a case in which the damage level is medium and f2 is in the range of 5 to 10. A LEVEL 3 represents a case in which the damage level is small and f2 is smaller than 5.

Next, the items of information necessary for an own organization about restoration information will be described. The items include, for example, position information f1 (prefectures, cities, towns, villages), T (planned restoration dates and times), restoration information R1 (property damage (facility damage, office building damage), and a transmission interval (t(time)+LEVELS 1, 2, and 3+f1)).

The thresholds of the items of restoration information will be described using a case in which a restoration level is classified into three levels as an example. First, a LEVEL 3 represents a case in which the restoration level is large and R1 is smaller than 5 days. A LEVEL 2 represents a case in which the restoration level is medium and R1 is in the range of 2 to 5. A LEVEL 3 represents a case in which the restoration level is small and R1 is greater than null.

The acquisition unit 131 acquires damage information and restoration information described above from lower apparatuses according to indicated items and stores the acquired information in the storage unit 12 in the data formats of vector information and raster information.

The aggregation unit 132 aggregates a plurality of damage information acquired by the acquisition unit 131 into information in a data format processible by the cooperation apparatuses 100 and 10 higher than own apparatus. The aggregation unit 132 aggregates a plurality of restoration information acquired by the acquisition unit 131 into information in a data format processible by the cooperation apparatuses 100 and 10 higher than own apparatus.

The aggregation unit 132 creates a shape file in which the data of vector information is aggregated for each of damage information and restoration information. The shape file is constituted by a set of a plurality of files of information on graphics, attribute information, position information, or the like. The aggregation unit 132 aggregates the data of raster information for each of damage information and restoration information. For example, the aggregation unit 132 synthesizes a plurality of image data representing raster information together for each of damage information and restoration information. The aggregation unit 132 generates aggregated information in which a shape file and the aggregated information of raster information are paired.

The visualization unit 133 visualizes damage information on the GIS according to the items. The visualization unit 133 visualizes restoration information on the GIS according to the items. The visualization unit 133 is also capable of developing damage information and restoration information aggregated by the aggregation unit 132 on the GIS to be visualized.

The communication control unit 134 controls communication processing in the cooperation apparatus 10. For example, when receiving an indication about aggregated items to be aggregated among the items of damage information and restoration information from the cooperation apparatus 100 via a network, the communication control unit 134 stores the received indication in the storage unit 12. Further, when receiving damage information or restoration information from the terminal apparatus 30 accommodated by the own apparatus, the communication control unit 134 stores the received information in the storage unit 12. Alternatively, when receiving aggregated information from the cooperation apparatuses 10 lower than the own apparatus, the communication control unit 134 stores the received information in the storage unit 12. Further, the communication control unit 134 performs to control to transmit damage information and restoration information aggregated by the aggregation unit 132 to the higher cooperation apparatuses 100 and 10.

The output unit 14 is realized by, for example, a display device such as a liquid crystal display, a printing device such as a printer, an information communication device, or the like and outputs document files to be processed, damage information and restoration information developed on the GIS by the control unit 13, or the like.

The communication unit 15 is a communication interface that transmits and receives various information to and from other apparatuses connected via a network or the like. The communication unit 15 is realized by a NIC (Network Interface Card) or the like and performs communication between other apparatuses and the control unit 13 (that will be described later) via an electric communication line such as a LAN (Local Area Network) and the Internet.

For example, the communication unit 15 receives an indication about aggregated items to be aggregated among the items of damage information and restoration information from the cooperation apparatus 100 via a network. Further, the communication unit 15 receives damage information or restoration information from the terminal apparatus 30 accommodated by the own apparatus. Alternatively, the communication unit 15 receives aggregated information from the cooperation apparatuses 10 lower than the own apparatus. Further, the communication unit 15 transmits damage information and restoration information aggregated by the own apparatus to the higher cooperation apparatuses 100 and 10.

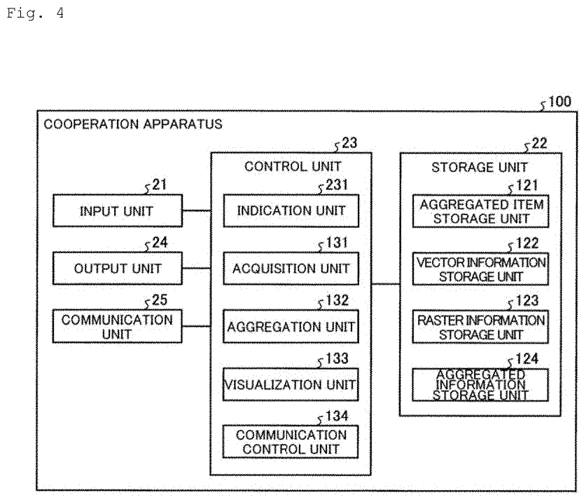

Next, the configuration of the cooperation apparatus 100 will be described. FIG. 4 is a diagram showing an example of the configuration of the cooperation apparatus 100 shown in FIG. 1. The cooperation apparatus 100 has an input unit 21, a storage unit 22, a control unit 23, an output unit 24, and a communication unit 25.

The input unit 21 has the same function as that of the input unit 11.

The storage unit 22 has the same function as that of the storage unit 12. The storage unit 22 has an aggregated item storage unit 121, a vector information storage unit 122, a raster information storage unit 123, and an aggregated information storage unit 124.

The control unit 23 has the same function as that of the control unit 13. The control unit 23 is configured to further have an indication unit 231 in comparison with the control unit 13.

The indication unit 231 indicates aggregated items to be aggregated to the lower cooperation apparatuses 10. Further, the indication unit 231 may set the items of information necessary for the COPs of the respective layers and indicate the same to the respective lower cooperation apparatuses 10.

Further, the aggregation unit 132 (second aggregation unit) aggregates a plurality of damage information received from the respective cooperation apparatuses 10-M1 and 10-M2 and aggregates a plurality of restoration information received from the respective cooperation apparatuses 10-M1 and 10-M2. The aggregation unit 132 generates the aggregated information of damage information and restoration information on the whole nation or the whole group company.

The visualization unit 133 develops damage information and restoration information aggregated by the aggregation unit 132 on the GIS to visualize damage information and restoration information on the whole nation or the whole group company (top level). The visualized information is used to grasp damage conditions and restoration conditions in the whole nation or the whole group company and make a decision for nationwide resource adjustment or the like.

The communication control unit 134 causes the respective lower cooperation apparatuses 10 to transmit aggregated items to be aggregated to the communication unit 15. Further, the communication control unit 134 causes the cooperation apparatuses 10 of the middle level and the low level of the lower layers to transmit feedback on the whole COP to the communication unit 15.

The output unit 24 has the same function as that of the output unit 14. The output unit 24 outputs damage information, restoration information, or the like on the whole nation or the whole group company (top level) developed on the GIS.

The communication unit 25 (reception unit, transmission unit) has the same function as that of the communication unit 15. The communication unit 25 receives damage information corresponding to aggregated items and restoration information corresponding to the aggregated items from the respective lower cooperation apparatuses 10. The communication unit 25 transmits the aggregated items to be aggregated to the respective lower cooperation apparatuses 10. The communication unit 25 transmits feedback on the whole COP to the communication units 15 of the cooperation apparatuses 10 of the middle level and the low level.

[Processing Procedure of Cooperation Processing]

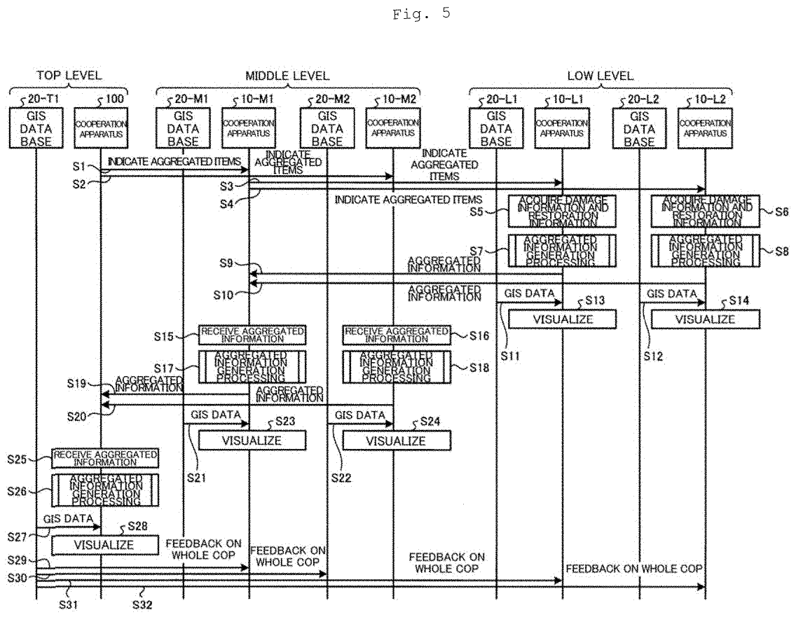

Next, the processing procedure of cooperation processing according the embodiment will be described. FIG. 5 is a sequence diagram showing the processing procedure of the cooperation processing according to the embodiment. In FIG. 5, the descriptions of the cooperation apparatuses 10-L3 and 10-L4 other than the cooperation apparatuses 10-L1 and 10-L2 of the low level connected to the cooperation apparatus 10-M1 of the middle level are omitted for simplification.

As shown in FIG. 5, the cooperation apparatus 100 first sets aggregated items to be aggregated among the items of damage information and restoration information and indicates the aggregated items to the cooperation apparatuses 10-M1 and 10-M2 of the middle level (steps S1 and S2). The cooperation apparatus 10-M1 indicates the aggregated items to the cooperation apparatuses 10-L1 and 10-L2 of the low level (steps S3 and S4).

At the low level, the cooperation apparatuses 10-L1 and 10-L2 acquire damage information, restoration information, or the like corresponding to the items to be acquired from the respective terminal apparatuses 30 accommodated by the own apparatuses (steps S5 and S6). The cooperation apparatuses 10-L1 and 10-L2 perform aggregated information generation processing to generate the aggregated information of damage information and restoration information corresponding to the previously-indicated aggregated items (steps S7 and S8) and transmit the aggregated information to the cooperation apparatus 10-M1 (steps S9 and S10). Further, the cooperation apparatuses 10-L1 and 10-L2 acquire GIS data from the GIS databases 20-L1 and 20-L2 connected to the cooperation apparatuses 10-L1 and 10-L2, respectively, (steps S11 and S12) and develop the damage information and the restoration information on the geographic information systems (GIS) to be visualized (steps S13 and S14).

Next, at the middle level, the cooperation apparatuses 10-M1 and 10-M2 receive the aggregated information from the respective cooperation apparatuses 10-L1 and 10-L2 (steps S15 and S16), perform aggregated information generation processing to generate the aggregated information of damage information and restoration information corresponding to the previously-indicated aggregated items (steps S17 and S18), and transmit the aggregated information to the cooperation apparatus 100 (steps S19 and S20). Further, the cooperation apparatuses 10-M1 and 10-M2 acquire GIS data from the GIS databases 20-M1 and 20-M2 connected to the cooperation apparatuses 10-M1 and 10-M2, respectively, (steps S21 and S22) and develop the damage information and the restoration information on the geographic information systems (GIS) to be visualized (steps S23 and S24).

Then, at the top level, the cooperation apparatus 100 receives the aggregated information from the cooperation apparatuses 10-M1 and 10-M2 (step S25) and performs aggregated information generation processing to generate the aggregated information of damage information and restoration information corresponding to the whole nation or the whole group company (step S26). Then, the cooperation apparatus 100 acquires GIS data from the GIS database 20-T1 (step S27) and develops the damage information and the restoration information on the GIS to be visualized (step S28). The cooperation apparatus 100 gives feedback on the whole COP to the cooperation apparatuses 10-M1, 10-M2, 10-L1, and 10-L2 of the middle level and the low level (steps S29 to S32).

[Processing Procedure of Aggregated Information Generation Processing]

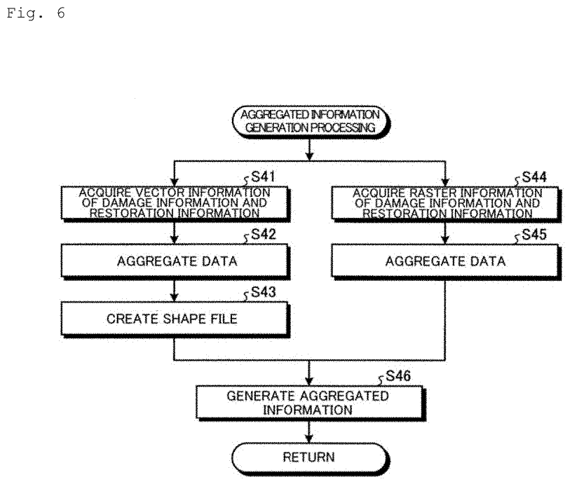

Next, the processing procedure of the aggregated information generation processing (steps S7, S8, S17, S18, and S26) shown in FIG. 5 will be described. FIG. 6 is a flowchart showing the processing procedure of the aggregated information generation processing shown in FIG. 5.

As shown in FIG. 6, the cooperation apparatuses 100 and 10 acquire the vector information of damage information and restoration information corresponding to aggregated items (step S41), aggregate data for each of the damage information and the restoration information (step S42), and create a shape file (step S43).

On the other hand, the cooperation apparatuses 100 and 10 acquire the raster information of the damage information and the restoration information corresponding to the aggregated items (step S44) and aggregate data (step S45). In FIG. 6, steps S41 to S43 and steps S44 and S45 are shown in parallel but may be set in series so that either the processing of steps S41 to S43 or the processing of S44 and S45 is performed precedently.

Next, the cooperation apparatuses 100 and 10 generate aggregated information in which the shape file and the aggregated information of the raster information are paired (step S46).

### Effects of Embodiment

As described above, the cooperation apparatuses 100 and 10 that perform the cooperation of damage information and restoration information between the respective layers are provided in the embodiment. The cooperation apparatuses 10 acquire damage information corresponding to previously-indicated aggregated items and restoration information corresponding to the previously-indicated aggregated items from a plurality of lower apparatuses.

Accordingly, the cooperation apparatuses 10 automatically acquire the damage information and the restoration information of previously-set items and therefore make it possible to promptly aggregate information without placing a burden on lower organizations in the embodiment.

Then, the cooperation apparatuses 10 aggregate the plurality of acquired damage information into information in a data format processible by cooperation apparatuses higher than the own apparatuses and aggregate the plurality of acquired restoration information into information in a data format processible by the cooperation apparatuses higher than the own apparatuses. Then, the cooperation apparatuses 10 transmit the aggregated damage information and the restoration information to the higher cooperation apparatuses 100 and 10.

Thus, even when the geographic information systems (GIS) of different specifications are used between the higher layers and lower layers, damage information and restoration information can be directly shared on the geographic information systems (GIS) between the higher layers and the lower layers according to the embodiment. In other words, since the damage information and the restoration information on the lower layers smoothly reach the higher layers in the present embodiment, the cooperation apparatuses 100 and 10 of the higher layers can promptly collect necessary information.

Accordingly, in the present embodiment, information necessary for making a decision and unifying condition recognition can be efficiently aggregated in the respective layers of the top level, the middle level, and the low level, and the cooperation of damage information and restoration information between the organizations of the multiple layers can be properly performed. Accordingly, since it is possible to promptly and efficiently make a decision with the whole unified information according to the present embodiment, restoration from a disaster can be assisted at an early stage.

[System Configuration, Etc.]

Further, the respective constituting elements of the respective apparatuses shown in the figures are functionally conceptual and do not necessarily need to be physically configured as shown in the figures. That is, the specific modes of distribution and integration of the respective apparatuses are not limited to those shown in the figures, and all or a part thereof can be functionally or physically distributed and integrated in arbitrary units according to various loads, use conditions, or the like. In addition, all or an arbitrary part of the respective processing functions performed by the respective apparatuses can be realized by a CPU and a program that is analyzed and performed by the CPU, or can be realized by wired logic as hardware.

Further, among the respective processing described in the present embodiment, all or a part of the processing described as being performed automatically can also be performed manually. Alternatively, all or a part of the processing described as being performed manually can be performed automatically by a known method. Besides, the processing procedures, the control procedures, the specific names, and the information including various data or parameters shown in the above document or the drawings can be arbitrarily changed unless otherwise specially noted.

[Program]

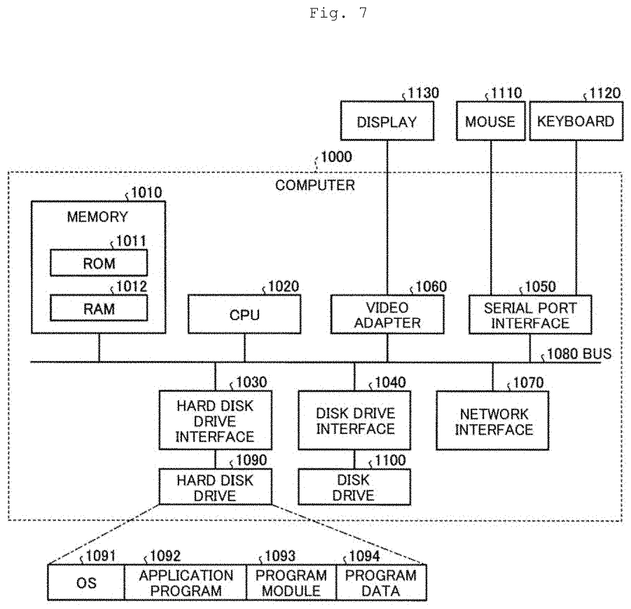

FIG. 7 is a diagram showing an example of a computer in which the cooperation apparatuses 100 and 10 are realized when a program is performed. A computer 1000 has, for example, a memory 1010 and a CPU 1020. Further, the computer 1000 has a hard disk drive interface 1030, a disk drive interface 1040, a serial port interface 1050, a video adapter 1060, and a network interface 1070. These respective units are connected to each other by a bus 1080.

The memory 1010 includes a ROM (Read Only Memory) 1011 and a RAM 1012. The ROM 1011 stores, for example, a boot program such as a BIOS (Basic Input Output System). The hard disk drive interface 1030 is connected to a hard disk drive 1090. The disk drive interface 1040 is connected to a disk drive 1100. For example, a detachable storage medium such as a magnetic disk and an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program defining the respective processing of the cooperation apparatuses 100 and 10 is installed as the program module 1093 in which a code capable of being performed by the computer 1000 is described. The program module 1093 is stored in, for example, the hard disk drive 1090. For example, the program module 1093 for performing the same processing as that of the functional configuration in the cooperation apparatuses 100 and 10 is stored in the hard disk drive 1090. Note that the hard disk drive 1090 may be replaced by a SSD (Solid State Drive).

Further, the setting data used in the processing of the embodiment described above is stored in, for example, the memory 1010 or the hard disk drive 1090 as the program data 1094. Then, the CPU 1020 reads the program module 1093 or the program data 1094 stored in the memory 1010 or the hard disk drive 1090 into the RAM 1012 and performs the same where necessary.

Note that the program module 1093 or the program data 1094 is not necessarily stored in the hard disk drive 1090 but may be stored in, for example, a detachable storage medium and read by the CPU 1020 via the disk drive 1100 or the like. Alternatively, the program module 1093 and the program data 1094 may be stored in another computer connected via a network (such as a LAN and a WAN). Then, the program module 1093 and the program data 1094 may be read by the CPU 1020 from the other computer via the network interface 1070.

The embodiment to which the invention that has been made by the present inventor is applied is described above. However, the present invention is not limited to the descriptions and the drawings constituting a part of the disclosure of the present invention according to the present embodiment. That is, all of other embodiments, examples, operational technologies, or the like that could be made by persons skilled in the art or the like on the basis of the present embodiment falls within the range of the present invention.

### REFERENCE SIGNS LIST

1 Cooperation system
10, 10-M1, 10-M2, 10-L1 to 10-L4, 100 Cooperation apparatus
20, 20-T1, 20-M1, 20-M2, 20-L1 to 20-L4 GIS database
30, 30-T1 Terminal apparatus
11, 21 Input unit
12, 22 Storage unit
13, 23 Control unit
14, 24 Output unit
15, 25 Communication unit
121 Aggregated item storage unit
122 Vector intonation storage unit
123 Raster information storage unit
124 Aggregated information storage unit
131 Acquisition unit
132 Aggregation unit
133 Visualization unit
134 Communication control unit
231 Indication unit

1. An information processing apparatus comprising:
acquisition circuitry that acquires damage information corresponding to previously-indicated aggregated items and restoration information corresponding to the previously-indicated aggregated items from a plurality of lower apparatuses; and
aggregation circuitry that aggregates the plurality of damage information acquired by the acquisition circuitry into information in a data format processible by an information processing apparatus higher than the own apparatus and aggregates the plurality of restoration information acquired by the acquisition circuitry into information in a data format processible by the information processing apparatus higher than the own apparatus.

2. The information processing apparatus according to claim 1, further comprising:
a transmitter that transmits the damage information aggregated by the aggregation circuitry and the restoration information aggregated by the aggregation circuitry to the higher information processing apparatus.

3. The information processing apparatus according to claim 1, further comprising:
visualization circuitry that develops the damage information aggregated by the aggregation circuitry on a GIS (Geographic Information System) to be visualized and develops the restoration information aggregated by the aggregation circuitry on the GIS to be visualized.

4. The information processing apparatus according to claim 1, wherein
the acquisition circuitry collects vector information of the damage information and vector information of the restoration information and acquires raster information of the damage information and raster information of the restoration information, and
the aggregation circuitry creates a shape file in which data of the vector information is aggregated for each of the damage information and the restoration information and aggregates data of the raster information for each of the damage information and the restoration information.

5. A cooperation system comprising:
an information providing apparatus; and
an information processing apparatus provided at a level higher than the information providing apparatus,
the information providing apparatus including
acquisition circuitry that acquires damage information corresponding to previously-indicated aggregated items and restoration information corresponding to the previously-indicated aggregated items from a plurality of lower apparatuses,
first aggregation circuitry that aggregates the plurality of damage information acquired by the acquisition circuitry into information in a data format processible by the information processing apparatus and aggregates the plurality of restoration information acquired by the acquisition circuitry into information in a data format processible by the information processing apparatus, and
a transmitter that transmits the damage information aggregated by the first aggregation circuitry and the restoration information aggregated by the first aggregation circuitry to the higher information processing apparatus,
the information processing apparatus including
indication circuitry that indicates the aggregated items to be aggregated to the information providing apparatus,
a receiver that receives the aggregated restoration information and the aggregated restoration information from the information providing apparatus,
second aggregation circuitry that aggregates the plurality of damage information received by the receiver and aggregates the plurality of restoration information received by the receiver, and
visualization circuitry that develops the damage information aggregated by the second aggregation circuitry on a GIS (Geographic Information System) to be visualized and develops the restoration information aggregated by the second aggregation circuitry on the GIS to be visualized.

6. An information processing method performed by an information processing apparatus, the information processing method comprising:
a step of acquiring damage information corresponding to previously-indicated aggregated items and restoration information corresponding to the previously-indicated aggregated items from a plurality of lower information processing apparatuses; and
a step of aggregating the plurality of acquired damage information into information in a data format processible by a higher information processing apparatus and aggregating the plurality of collected restoration information into information in a data format processible by the higher information processing apparatus.

7. A non-transitory computer readable medium including an information processing program causing a computer to perform:
a step of acquiring damage information corresponding to previously-indicated aggregated items and restoration information corresponding to the previously-indicated aggregated items from a plurality of lower information processing apparatuses; and
a step of aggregating the plurality of acquired damage information into information in a data format processible by a higher information processing apparatus and aggregating the plurality of collected restoration information into information in a data format processible by the higher information processing apparatus.
